(19) United States
(12) Patent Application Publication
(10) Pub. No.: US 2012/0303393 A1
(43) Pub. Date: Nov. 29, 2012

(54) LIFE INSURANCE PRODUCTS UNDER A SINGLE APPROVED FORM

(75) Inventor: Gabriel R. Schiminovich, Portland, OR (US)

(73) Assignee: M Financial Group, Portland, OR (US)

(21) Appl. No.: 13/486,993

(22) Filed: Jun. 1, 2012

Related U.S. Application Data
(63) Continuation of application No. 12/585,087, filed on Sep. 2, 2009, now abandoned.
Application No. 12/585,087 is a continuation of application No. 12/078,448, filed on Mar. 31, 2008, now abandoned.
Application No. 12/078,448 is a continuation of application No. 10/096,100, filed on Mar. 13, 2002, now abandoned.
(60) Provisional application No. 60/275,030, filed on Mar. 13, 2001.
(60) Provisional application No. 60/333,748, filed on Nov. 29, 2001.

(51) Int. Cl. G06Q 40/08

(52) U.S. Cl. 705/4

(57) ABSTRACT

A system and method for generating life insurance products under a single approved form. In one aspect, a system and method are provided for determining a premium schedule by selecting a death benefit; targeting a projected balance of an account associated with the product; designating at least one premium band; generating, in response to a deferral determination for at least one premium-based charge for at least one premium band, factors for allocating charges associated with the product; and calculating the premium schedule. In another aspect, a system and method are provided for determining a death benefit, and in another aspect, a system and method are provided for determining a projected balance of an account associated with a life insurance product.

### CROSS REFERENCED TO RELATED APPLICATIONS

This application is a continuation of non-provisional application Ser. No. 12/585,087, filed Sep. 2, 2009, which is a continuation of non-provisional application Ser. No. 12/078,448, filed Mar. 31, 2008, which is a continuation non-provisional application Ser. No. 10/096,100, filed Mar. 13, 2002 which claims priority to provisional application No. 60/275,030, filed Mar. 13, 2001, which is incorporated herein by reference, and to provisional application No. 60/333,748, filed Nov. 29, 2001, which is incorporated herein by reference.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF INVENTION

The present invention relates to the field of life insurance. more particularly, the present invention relates to a system and method for generating life insurance products under a single approved form.

### BACKGROUND OF THE INVENTION

Generally, a life insurance contract provides economic protection against the risk of income cessation or liabilities associated with death. A life insurance contract, or insurance product, typically provides for one party (the customer) to pay a premium or premiums and for another party (the insurer) to pay a defined amount upon the death of the insured, a death benefit. For example, many individuals use life insurance products as a means to provide for the income needs of surviving dependent family members, pay federal or state estate taxes, pay debts, or make charitable donations. Many businesses use life insurance products as a means to provide a basic level of financial security for employees and their dependents, fund employee benefits, provide funds to continue business operations in the event a key employee dies (known as “key-man insurance”), or provide financial liquidity to minimize business disruption in the event of the owner's death, disability, retirement, or other withdrawal from the business (known as “buy-sell” arrangements).

The cost for a given level of life insurance protection generally increases as the insured ages. Life insurance policy premiums typically pay for the cost of death benefit protection within a current period (the cost of insurance), for pre-funding the cost of future protection, and to cover other policy charges. Premiums associated with pre-funding the future cost of insurance protection are invested by the insurance company and held in a reserve. Generally, different types of contracts give customers various rights as to when and at what level premiums are paid, access to the policy reserves (known as “account value” or “cash value”), and some limited options as to which types of investments to invest the reserves. Certain types of insurance contracts, known as “variable universal life insurance” contracts, are often purchased by individuals and businesses who desire maximum control over the premiums paid into their investment account—when premiums are paid, how much is paid at a given time, and how to invest the reserves. These policies permit a customer to pay premiums at the time and in the amount of the customer's choosing, within certain legal and regulatory limits, and to direct the investment of the funds associated with their policies among a menu of different investment accounts, which are roughly similar to choices found in mutual fund-type investments.

In addition to funding the cost of current insurance protection and the allocation of funds to a policy reserve account, a portion of the premium or premiums paid by a customer to the insurer may be used to pay for certain charges incurred by the insurer, for example, distribution expenses, periodic charges, investment advisory expenses, and government taxes. An insurance contract typically has a given set of charges from which an insurance company expects to recover the expenses that it incurs. The art of insurance product pricing is to develop a package of policy charges that will recover the expenses that are incurred by the insurance company over time, accounting for certain risks and the time value of money, while at the same time delivering an attractive product to the customer. Variations among products in the marketplace are most often driven by attempts by the product developers to satisfy differing customer preferences while taking into account the risks presented by those preferences. For example, the amount of policy charges and the timing of when they are set in the insurance contract affect the amount of the customer's investment account associated with the policy. If charges are designed to recover costs quickly, the customer's investment account in the early years would be lower than if the policy charges were designed to recover costs over a longer period of time. However, the quicker the carrier recovers its costs generally results in a better long-term value for the customer, so a customer's preference for long-term results versus short-term results often drives different charge configurations in the marketplace. Thus, for example, a policy which is designed to recoup the insurer's costs as quickly as possible and provide the customer with a maximized death benefit twenty years in the future may be highly desirable to some customers but not to others. This balancing of the customer's and the insurer's goals and desires increases the complexity in designing and selecting the best-suited life insurance product.

Traditionally, however, life insurance products are relatively inflexible with regard to customized features to meet the objectives of specific customers. Life insurers, products and agents, are subject to a combination of state and federal government regulations designed to protect the insured, policy owners, and beneficiaries against unfair and deceptive provisions and practices, and to prevent the use of insurance for purposes other that what was intended. For example, states often require that a policy contract form may not be used until a specimen policy contract form is filed with, and approved by, the state's insurance department. Most state statutes contain provisions, as recommended by the National Association of Insurance Commissioners (NAIC), regulating aspects of life insurance contract provisions, such as grace periods, premium payments, incontestability, misstatements of age, annual apportionment of dividends, surrender values and options, policy loans, settlement options, and reinstatement.

The Internal Revenue Code provides a definition of life insurance for federal income tax purposes, which determines whether or not an insurance contract will be accorded the tax benefits associated with life insurance, e.g., tax deferred growth of the earnings of an associated investment account and receipt of death benefits free of income tax. Generally, the definition of life insurance contained in the Internal Revenue Code is designed to prevent the unnecessary build up of cash in a policy's investment account relative to the amount of death benefit protection being provided by the insurer. This limits the customer's ability use life insurance as an investment vehicle and also limits the customer's ability to control the investment of premiums with regard to particular investments.

Additionally, certain insurance products (commonly known as “variable products”) are classified as securities and therefore are regulated by the U.S. Securities and Exchange Commission (SEC), the National Association of Securities Dealers (NASD), the Municipal Securities Rulemaking Board (MSRB), and various state agencies.

In order to create a new insurance product structure, an insurance company typically invests several months of time in order to create a proper charge structure to offer a competitive product, based on the customer profile it intends to attract and the associated financial and health risks, that complies with the regulatory review process for all applicable statutory and regulatory requirements while meeting the insurance company's requirements for risk and earnings.

This “manufacturing” process often results in delays for creating new regulatory-approved life insurance products tailored to meet certain customer needs or in the decision by the insurer to simply forego the creation of a product for a particular type of customer because it does not have the flexibility to offer such a product responsive to the customer's needs on a timely basis.

Furthermore, traditional life insurance products typically do not give insurance representatives broad flexibility to allocate insurance policy charges in ways that meet customer objectives and at the same time manage risks for the insurer that underwrites the product. For example, traditional life insurance products typically do not provide customer flexibility to choose different charge amortization configurations to generate a product that can meet differing customer preferences by permitting the amortization of different charges associated with the product over differing periods of time. Recently, life insurance product offerings have included limited options to allow insurance representatives to alter the commission structure to affect policy charges. However, insurance companies are often only able to offer customers a limited number of policies which, in turn, are intended to meet the objectives of certain types of customers. Representatives are frequently not able to illustrate different insurance products in a real-time fashion that immediately shows the consequences of various customer choices in benefits or premiums. Representatives also have limited flexibility to change or defer commission schedules in order to generate a policy that meets a customer's objectives and thereby make a sale.

For the foregoing reasons, there is a need for a way of generating life insurance products under a single regulatory-approved form that permits the flexible distribution and recovery of charges and expenses. There is a need for practically real-time illustration of sample policies generated using criteria specified by an insurance customer.

### SUMMARY OF THE INVENTION

The present invention is directed to systems and methods for generating life insurance products under a single approved form. The invention advantageously provides a flexible process for generating insurance products tailored to meet customer needs without having to submit new forms for regulatory approval. A single regulatory-approved form according to the present invention is sufficient to facilitate generating a plurality of life insurance policies. The insurance regulatory forms shown in Appendix A, Sample Product Regulatory Submission, which is part of this specification, are for illustrative purposes and are examples of forms sufficient to obtain regulatory approval of life insurance products embodying the present invention. In view of this specification, including Appendices A-F, it would be apparent to a person of ordinary skill in the art how to create insurance regulatory forms for various life insurance policy offerings using or embodying the present invention. The MAGNASTAR Private Placement Variable Life product described in the appendices is a product of M Financial Group.

The invention provides an insurance representative the capability to flexibly distribute charges associated with an insurance product to various balancing items of the insurance product such as the premium stream or the cash value. The invention also provides the capability to distribute charges across a plurality of premium bands and a plurality of time periods. Premium bands are designed such that premiums up to one amount have a certain expense load while premiums over that amount may have a different expense load.

The invention advantageously provides a system and method for illustrating life insurance products tailored to customer needs in practically real-time. In embodiments, the system receives inputs for variables such as the death benefits desired by the customer, the cash values desired for various time periods, and premium levels and in response generates an illustrative life insurance product. The interactive application permits practically real-time adjustments of insurance products to meet customer needs.

Applied to private placement variable life insurance, the present invention facilitates a large universe of investment choices for individual life insurance products. The invention provides qualified customers with the ability to invest in investments exempt from registration under Regulation D of the 1933 Securities Act, as well as in registered investment funds.

In one aspect of the invention, a method is provided for determining a premium schedule for a life insurance product under a single regulatory-approved form by selecting a death benefit; targeting a projected balance of an account associated with the product; designating at least one premium band; generating, in response to a deferral determination for at least one premium-based charge for at least one premium band, factors for allocating charges associated with the product; and calculating the premium schedule. A deferral determination is an option that allows an insurance representative or a customer to presently incur a premium-based charge or to defer the charge to a future charge schedule. In a further aspect of the invention, the calculated premium schedule is consistent with regulatory requirements, which may include meeting the qualifications for a life insurance policy. In yet a further aspect of the invention, a premium schedule is calculated for each of a plurality of time periods.

In another aspect of the invention, a method is provided for determining a death benefit for a life insurance product under a single regulatory-approved form by selecting a premium; targeting a projected balance of an account associated with the product; designating at least one premium band; generating, in response to a deferral determination for at least one premium-based charge for at least one premium band, factors for allocating charges associated with the product; and calculating the death benefit. In a further aspect of the invention, the calculated death benefit is consistent with regulatory requirements, considering the selected premium amount. In yet a further aspect of the invention, a death benefit is calculated for each of a plurality of time periods.

In still another aspect of the invention, a method is provided for determining a projected balance of an account associated with a life insurance product under a single regulatory-approved form by choosing a death benefit; selecting a premium; designating at least one premium band; generating, in response to a deferral determination for at least one premium-based charge for at least one premium band, factors for allocating charges associated with the product; and calculating the projected balance. The projected balance or projected cash value may be calculated by estimating a financial earnings rate for the balance after subtracting the cost of insurance and policy charges from the premium. In a further aspect of the invention, the calculated projected balance is consistent with regulatory requirements. In yet a further aspect of the invention, a projected balance is calculated for each of a plurality of time periods.

In another aspect of the invention, the methods of generating life insurance products under a single regulatory-approved form include the process of determining a projected earnings rate on the projected balance.

The life insurance products of the invention include single life policies, joint life policies, joint last-survivor life policies, or portfolios of policies. The life insurance products may be from a class of insurance policies meeting government regulatory definitions for life insurance and consisting of, but not limited to, term life, endowment, annuity, whole life, universal life, variable life, variable universal life, private placement variable life, and combinations thereof.

In another aspect of the invention, methods for generating life insurance products under a single approved form may include selecting a maximum or minimum death benefit or a maximum or minimum premium level. The methods for generating life insurance products under a single approved form may also include targeting a maximum or minimum projected balance of an account associated with the product.

In yet another aspect of the invention, methods for generating life insurance products under a single approved form may include generating factors for allocating charges responsive to a first deferral determination to defer a first amount of charges and generating revised factors for allocating charges responsive to a revised deferral determination to defer a revised amount of charges. The factors are mathematical variables that can be used to allocate policy charges to the policy's premium schedule and assets. In embodiments of the invention, the algorithms for calculating the factors are described in Appendix B, Product Definition, which is part of this specification. The methods for generating life insurance products may also include selecting a revised death benefit and calculating a revised premium schedule or a revised projected balance. The methods for generating life insurance products may also include targeting a revised projected balance and calculating a revised premium schedule or a revised death benefit responsive to the revised projected balance.

In another aspect of the invention, methods of illustrating or offering a life insurance product under a single approved form are provided.

In a further aspect of the invention, charges associated with insurance products may include costs of insurance charges, periodic charges, asset-based charges, or combinations of such charges.

In another aspect of the invention, life insurance products generated by the processes of the invention are provided.

In another aspect of the invention, a computer program product is provided comprising a computer usable medium having computer program logic recorded on it for enabling a processor in a computer system to facilitate creating a life insurance product under a single regulatory-approved form. The computer program logic may comprise a storage means for enabling the computer system to accept information including a death benefit, a projected balance of an account associated with the product, a projected earnings rate on the projected balance, at least one premium band, and factors for allocating charges associated with the life insurance product. The computer program logic may also comprise a calculating means for calculating, consistent with regulatory requirements, a premium schedule, responsive to the stored death benefit, the projected balance, the projected earnings rate, the premium band, and the factors.

In another aspect of the invention, a life insurance system is provided comprising a data processing apparatus for storing life insurance base product tables and regulatory requirements, and input means for inputting instructions to the apparatus to calculate a premium schedule associated with a life insurance product responsive to a selected death benefit, a projected balance of an account associated with the life insurance product, at least one designated premium band, and factors for allocating charges associated with the life insurance product, the factors being responsive to a deferral determination for at least one premium-based charge for each premium band. In a further aspect of the invention, the premium schedule is also responsive to a projected earnings rate on the projected balance.

In another aspect of the invention, a life insurance system is provided comprising a data processing apparatus for storing life insurance base product tables and regulatory requirements, and input means for inputting instructions to the apparatus to calculate a death benefit responsive to a selected premium schedule, a projected balance of an account associated with the life insurance product, at least one designated premium band, and factors for allocating charges associated with the life insurance product, the factors being responsive to a deferral determination for at least one premium-based charge for each premium band. In a further aspect of the invention the death benefit is also responsive to a projected earnings rate on the projected balance.

In another aspect of the invention, a life insurance system is provided comprising a data processing apparatus for storing life insurance base product tables and regulatory requirements, and input means for inputting instructions to the apparatus to calculate a projected balance of an account associated with the life insurance product responsive to a selected death benefit, a selected premium schedule, at least one designated premium band, and factors for allocating charges associated with the life insurance product, the factors being responsive to a deferral determination for at least one premium-based charge for each premium band. In a further aspect of the invention, the projected balance is also responsive to a projected earnings rate on the projected balance.

Additional features and advantages of the invention are set forth in part in the description that follows, and in part are apparent from the description, or may be learned by practice of the invention.

### BRIEF DESCRIPTION OF THE DRAWINGS

The accompanying drawings, which are incorporated in and form a part of the specification, illustrate embodiments of the present invention and, together with the description, serve to explain the principles of the invention.

FIG. 1 illustrates a flowchart depicting an embodiment of a process of the invention;

FIG. 2 illustrates an application of an embodiment of the invention for entering product information;

FIG. 3 illustrates a pull-down menu in an application of an embodiment of the invention;

FIG. 4 illustrates an application of an embodiment of the invention for entering customer information;

FIG. 5 illustrates an application of an embodiment of the invention for entering product characteristics;

FIG. 6 illustrates a data entry application of an embodiment of the invention for entering death benefit levels;

FIG. 7 illustrates a data entry application of an embodiment of the invention for entering premium levels;

FIG. 8 illustrates an application of an embodiment of the invention for entering product characteristics;

FIG. 9 illustrates an application of an embodiment of the invention for entering fund options;

FIG. 10 illustrates a data entry application of an embodiment of the invention for entering rates of return;

FIG. 11 illustrates an application of an embodiment of the invention for entering premium band options;

FIG. 12 illustrates an application of an embodiment of the invention for allocating commissions;

FIG. 13 illustrates a data entry application of an embodiment of the invention for entering commission levels;

FIG. 14 illustrates a data entry application of an embodiment of the invention for entering commission levels;

FIG. 15 illustrates an application of an embodiment of the invention for entering distribution characteristics;

FIG. 16 illustrates a pull-down menu in an application of an embodiment of the invention;

FIG. 17 illustrates an application of an embodiment of the invention for entering rider options;

FIG. 18 illustrates a sample illustration of an embodiment of the invention; and

FIG. 19 illustrates an embodiment of a system of the invention.

### DETAILED DESCRIPTION

In describing embodiments of the invention, specific terminology will be used for the sake of clarity. However, the invention is not intended to be limited to the specific terms selected, and it is to be understood that each specific term includes all equivalents.

The present invention provides a system and method for generating life insurance products under a single approved form. In embodiments, the invention receives information inputs, such as a death benefit level and a projected cash value balance, needed to generate a life insurance product. The inputs are processed with predetermined insurance tables containing information concerning insurance company costs, such as a company's periodic charges, cost of providing mortality protection, government taxes, or contribution to profits. Examples of insurance data tables used in practicing the invention are shown in Appendix C, Exemplary Inputs For Product, for illustrative purposes and are part of this specification. The first two pages of Appendix C are an index of the sample insurance data tables, and the second column of the index references the corresponding sections of the Product Definition in Appendix B. In view this specification, including Appendices A-F, it would be apparent to a person of ordinary skill in the art how to populate and create additional insurance tables that meet the various requirements and goals of different insurance companies for their life insurance products embodying the present invention.

User inputs and the data tables are processed in order to calculate the complete schedules of a life insurance product, as more fully explained below. In embodiments of the present invention, the algorithms for processing the input information and generating a product are described in Appendix B, Product Definition.

In an embodiment of the invention, a user inputs parameters for a life insurance product such as death benefit levels, projected balances for the cash value of the product, a projected earnings rate for cash value balances, and premium levels. Typically, these variables are tied together by a single equation or calculation or a series of equations and calculations. For example, inputs for death benefit levels, projected balances for the cash value of the product, and a projected earnings rate for cash value balances can be used to calculate a schedule of premium levels. Likewise, inputs for projected balances for the cash value of the product, a projected earnings rate for cash value balances, and premium levels can be used to calculate death benefit levels. Inputs for death benefit levels, a projected earnings rate for cash value balances, and premium levels can be used to calculate projected balances for the cash value of the product. For example, a cash value can be calculated by subtracting the death benefit level and policy charges from the premium. Thus, for the embodiments described in this specification, an example explaining how premium schedules are illustrated or generated will also enable a person of skill in the art how to illustrate or generate death benefit levels or cash value balances for a life insurance product.

In embodiments of the invention, an input for each such variable may be relevant for the entire duration of a life insurance product. In other embodiments, the parameters of a life insurance product may change over time, and each such variable may have different values at different times. In these cases, the invention facilitates the entry of multiple values for each such variable corresponding to different time periods.

In embodiments, the invention allows insurance representatives to change the pricing parameters or loads of a life insurance product in order to meet the objectives of a customer. The representative has the flexibility to determine how various loads associated with the product are charged to the assets of the product. For example, the representative may use the invention to customize the commission schedule so that part of the representative's compensation is deferred into future years. As another example, the customer may also want to defer the payment of government taxes into future years in order to provide greater funds in early policy years to the product's investment option. In such cases, the insurance company essentially fronts the costs of the deferred charges in anticipation of recovering these costs over time. Thus, the insurance company assumes some persistency risk, risk that the policy or product line is terminated before costs can be recovered. However, the invention allows the insurance company to manage this additional risk, for example, by adjusting the pricing parameters of the insurance product.

Life insurance product charges such as the cost of insurance, government taxes, distribution commissions, licensing fees, periodic charges, product development expenses, marketing expenses, investment advisory fees, and insurance company profits can be funded from the various assets of the product. For example the charges may be deducted from the payment of premiums, investment earnings, or even through the reduction in benefits paid out. In embodiments, the invention distributes the charges to the various product assets in a manner consistent with customer objectives and regulatory requirements.

In embodiments, charges may also be distributed based on the asset balances of a life insurance product. Asset levels may, for example, be divided into different levels or bands so that each band is responsible for covering a portion of the charges. In embodiments, this asset-based method of allocating charges gives preferential treatment to customers that contribute greater funds to policies.

In embodiments of the invention, multiple life insurance products can be banded together in a portfolio. The various charges and assets of all the products can be pooled and analyzed in order to coordinate risk and coverage.

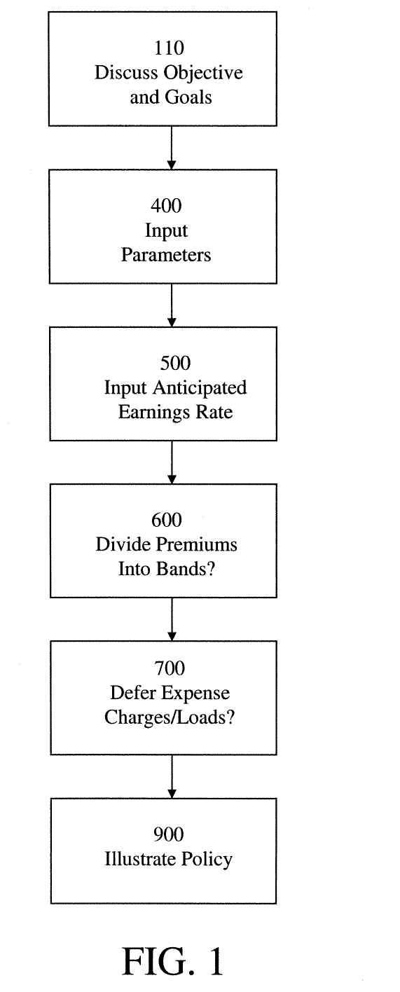

With reference to the drawings, in general, and FIGS. 1 through 19 in particular, embodiments of the present invention are described.

FIG. 1 illustrates a flow diagram of a process of an embodiment of the present invention. In an embodiment of the invention, this process represents a scenario for illustrating or generating a life insurance product in which an insurance representative may respond to specific customer needs in practically real-time. The process begins at step 110 where the representative discusses the objectives and goals of the customer. Objectives may include, for example, maximizing the death benefit for the customer during specific time periods or throughout the duration of a life insurance policy. On the other hand, the customer may want to maximize the surrender cash value of a policy at various time periods, for example, at the beginning of the policy. The customer may also have constraints such as the amount of money available to invest in a life insurance product or limitations in the ability to make future premium payments. The customer's objectives may also include or be based on tax considerations.

In the embodiment depicted in FIG. 1, the representative begins the process of illustrating or generating a life insurance product that achieves a customer's objectives. In step 400, the customer or the representative inputs into a computer system, programmed according to the invention, parameters for the proposed life insurance product. In this embodiment, these parameters include a death benefit amount, a target cash balance, and a desired premium level. These three variables may be the customer's main concern because they define the benefits and costs of the product to the customer. The three variables are also interrelated because each can be calculated using the values of the other two.

The death benefit amount may remain constant for the duration of the policy or may change over time in accordance with the customer's objectives. In embodiments, the death benefit is not fixed by the customer, but is calculated according to the invention after the other variables have been determined.

The target cash balance may be constant for the duration of the policy or may change over time in accordance with the customer's objectives. For example, the customer may want to maximize the cash balance at the beginning of a policy term to minimize the accounting impact of the purchase. The customer may also want to maximize the cash balance in order to maximize the potential investment return. In other embodiments, the cash balance is not fixed by the customer, but is calculated according to the invention after other variables have been determined.

The premium level may be constant for the duration of the policy or may change over time in accordance with the customer's objectives. In other embodiments, the premium level is not fixed by the customer, but is calculated according to the invention after other variables have been determined.

In step 500 of the embodiment depicted in FIG. 1, the customer or representative inputs an anticipated earnings rate for any cash balance. The anticipated earnings rate or investment rate of return is used to calculate the anticipated growth of the cash balance over time, which may affect the values of other variables, such as the death benefit, in future years. Although in embodiments there are no constraints on the value of the anticipated earnings rate, it is preferable to input a realistic rate in order to generate a life insurance product that will most likely perform as predicted. For example, the customer may decide to input the historical performance of the investment vehicle chosen for the policy.

In step 600 of the embodiment depicted in FIG. 1, the insurance representative or the customer determines if it is desirable to divide premium payments into multiple “bands” to provide flexibility in charging loads and expenses to insurance product's assets. For example, insurance product may be defined so that 10% of the first $10,000 in a premium payment (i.e., $1,000) is used for product charges, such as cost of insurance, while 5% of the next $10,000 is used for such charges.

In step 700 of the embodiment depicted in FIG. 1, the customer or representative determines if it is desirable to defer charging certain expenses to the proposed policy or amortize a portion of the charges associated with the policy. For example, in order to meet the customer's objectives, the representative may propose to defer the assessment of commission charges for a period of time or to defer the assessment of other charges, such as the cost of insurance. This deferral decision may be made for each premium band of a policy. The deferral decision may also be made for specific periods of time during the life of the generated policy.

In step 900 of the embodiment depicted in FIG. 1, a life insurance product in accordance with the inputs from the preceding steps illustrated. Depending on which variables are inputted, the policy may include a premium schedule calculated by the invention or anticipated cash balances calculated by the invention or a schedule of death benefits calculated by the invention. The customer or representative then review the illustrated policy. If the policy satisfactorily meets the customer's objectives, the representative may then immediately prepare a contract offer for the customer. If the illustrated policy is not satisfactory, the customer or representative may, according to the invention, go back and change the inputs for one or more variables.

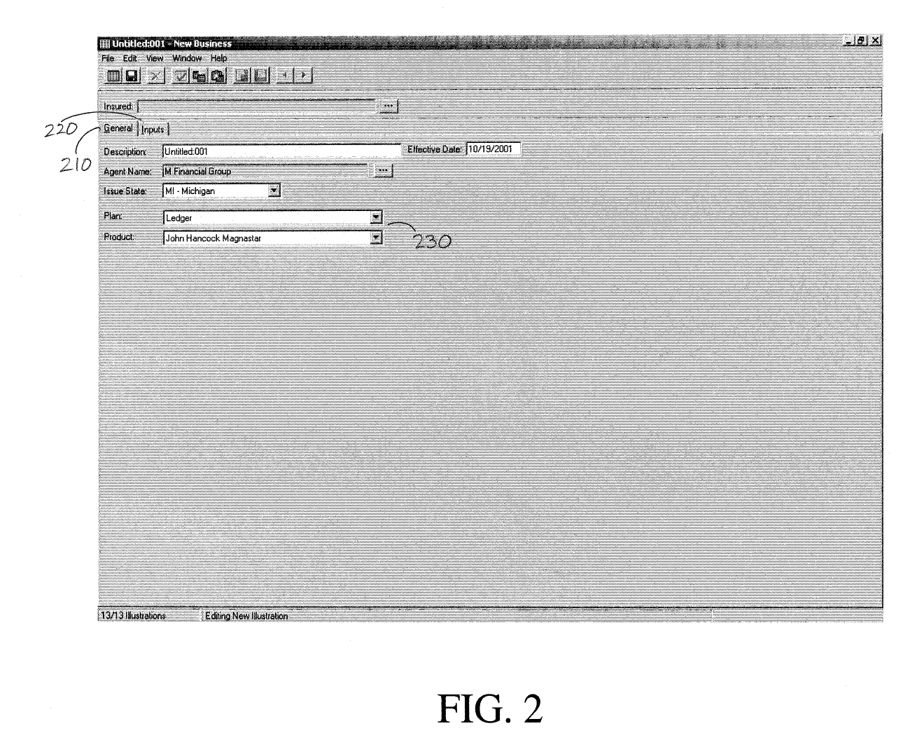

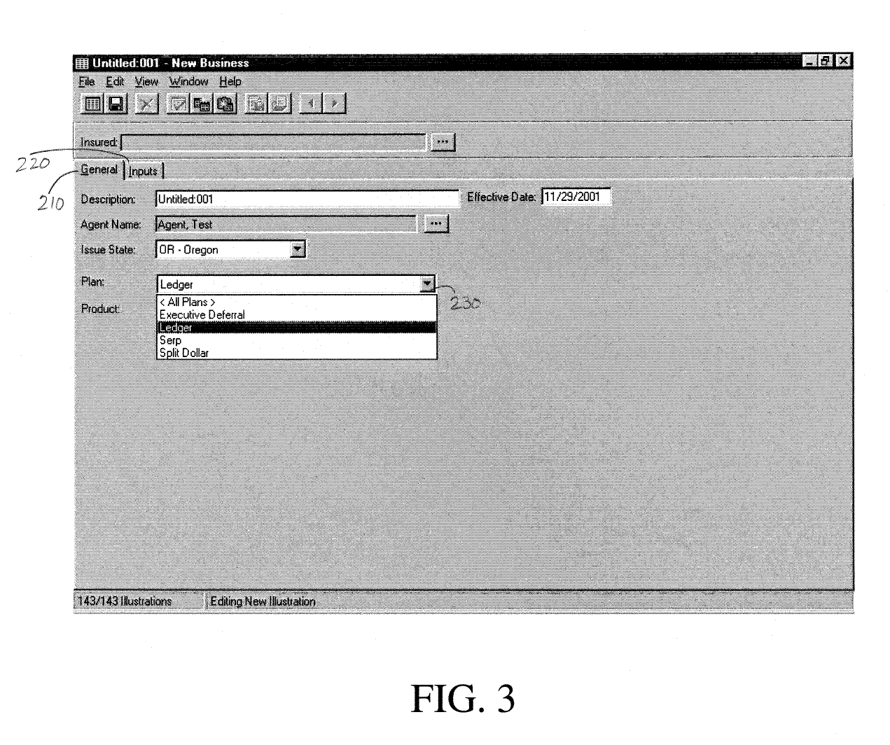

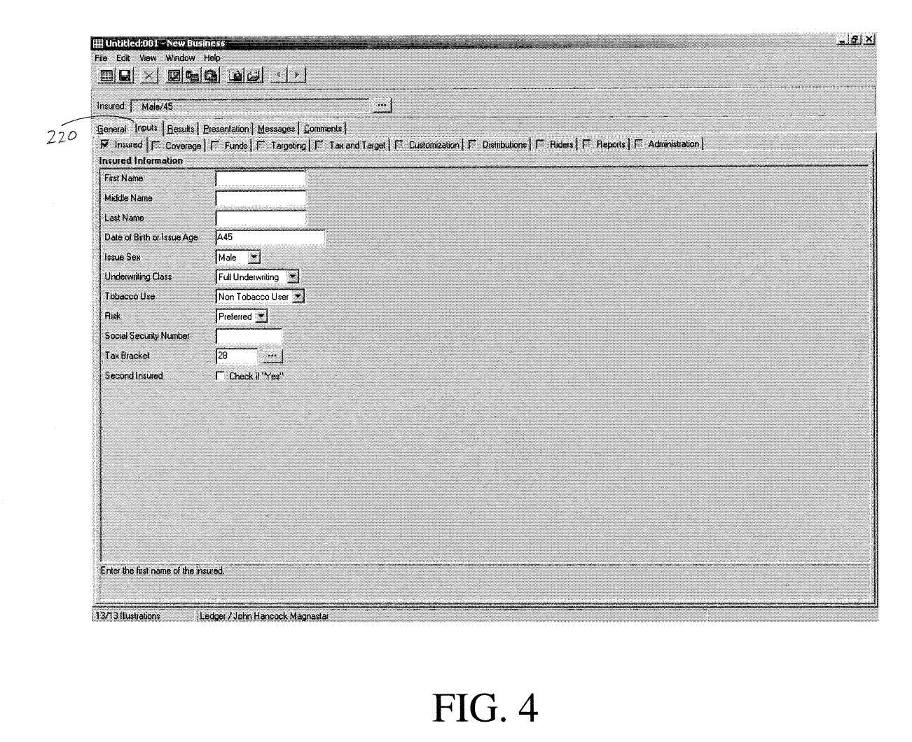

FIGS. 2 through 4 illustrate embodiments that allow a user to input customer background information into a computer application that illustrates and generates life insurance products according to the invention. FIG. 2 depicts an embodiment of a computer application screen. Tab 210 is labeled “General” and is the starting point for entering background information for a proposed life insurance product. Choosing button 230 allows a user to select a plan from a pull-down menu. FIG. 3 depicts an embodiment of the pull-down menu. By selecting Tab 220, labeled “Inputs,” a user may change the application screen to the embodiment illustrated in FIG. 4. The computer application screen depicted in FIG. 4 contains spaces for inputting customer background information.

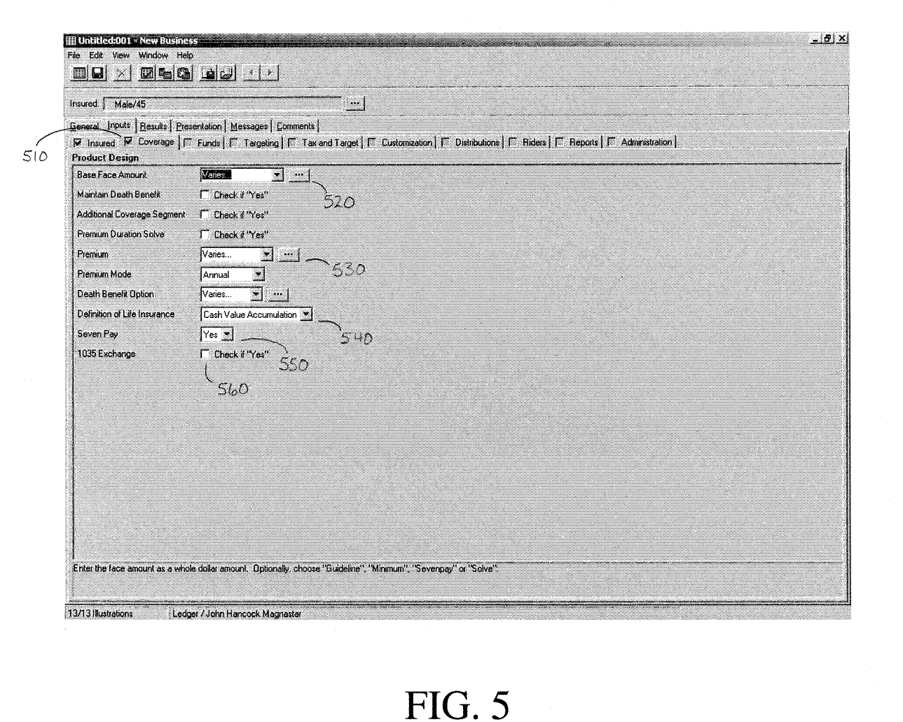

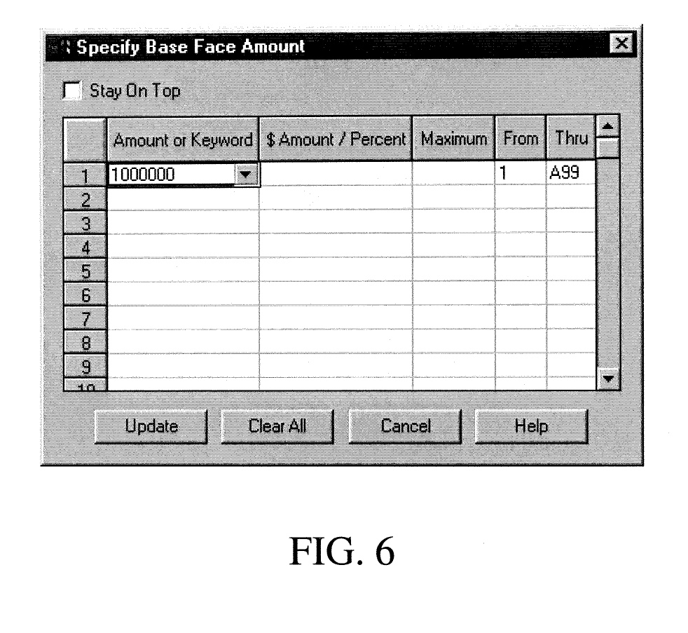

FIG. 5 illustrates another application screen of an embodiment which may be viewed by selecting tab 510, labeled “Coverage.” This application screen contains entries for inputting a desired death benefit and a desired premium level. In embodiments, the desired death benefit amount may be entered by choosing button 520. In embodiments, choosing button 520 will take the user to the application screen depicted in FIG. 6. In FIG. 6, the user may enter the desired death benefit amount for the various time periods of the policy. The desired death benefit may be fixed for the duration of the policy or may vary over time. The death benefit itself may be a payout of the face amount or the face amount plus an account value. The death benefit may also include additional amounts provided for by riders incorporated into the policy. In embodiments, the policy may fix a minimum death benefit in order to meet IRS requirements for life insurance. In embodiments, the invention determines the death benefit amount based on the values chosen for the other variables.

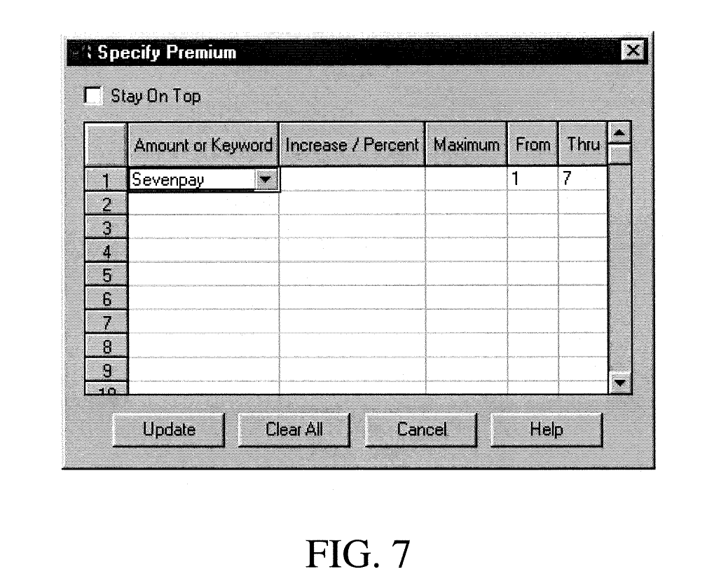

In embodiments, a premium level may be selected by choosing button 530. In embodiments, choosing button 530 will take the user to the application screen depicted in FIG. 7. In FIG. 7, the user may enter the desired premium level for the various time periods of the policy. The premium level may be fixed for the duration of the policy or may vary over time. In embodiments, the invention determines the premium level based on the values chosen for the other variables.

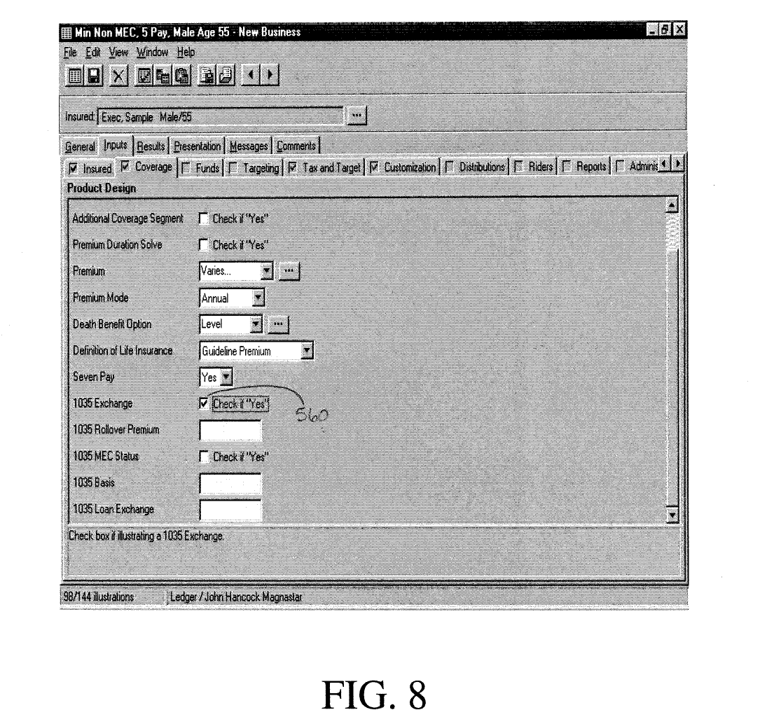

In FIG. 5, a user may also choose button 540 to reveal a pull-down menu in order to select a Definition of Life Insurance. In embodiments, the Definition of Life Insurance may be based on a “cash value accumulation” test or a “guideline premium” test. The user may also decide whether the policy will be a “Seven Pay” as defined by Section 7702A of the Internal Revenue Code. The decision may alter the policy premium or face amount in order to comply with tax requirements. The user may also decide whether the policy will involve a “1035 Exchange,” which includes accepting assets from an existing life insurance product in order to facilitate a tax deferred exchange of life insurance products. If the user selects “1035 Exchange” by checking box 560, additional entries appear, as illustrated by FIG. 8, requesting information about the existing policy in order to assure compliance with government tax requirements.

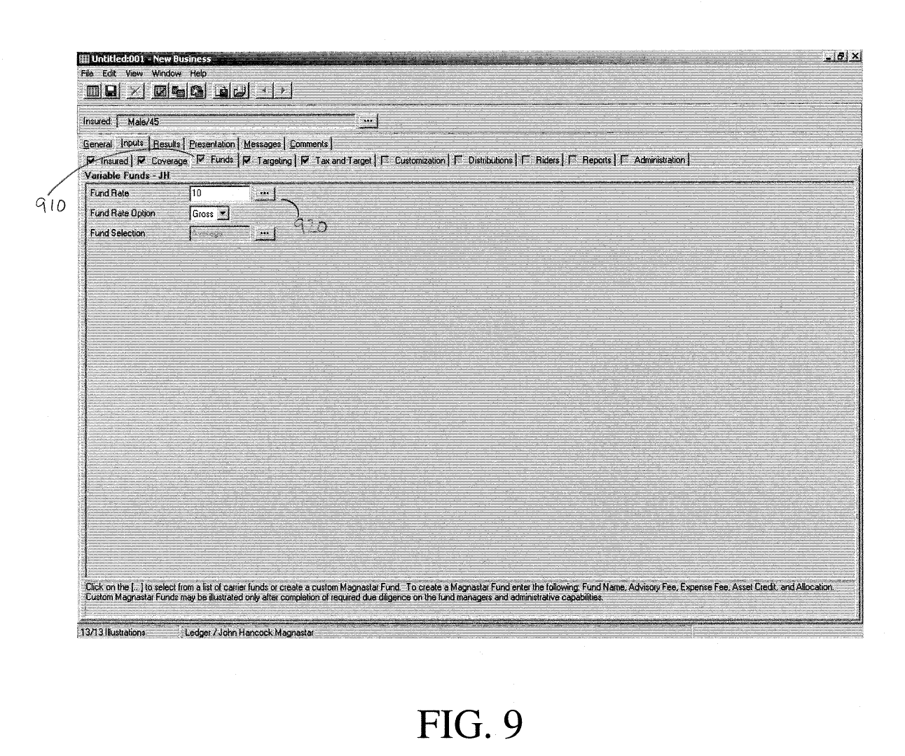

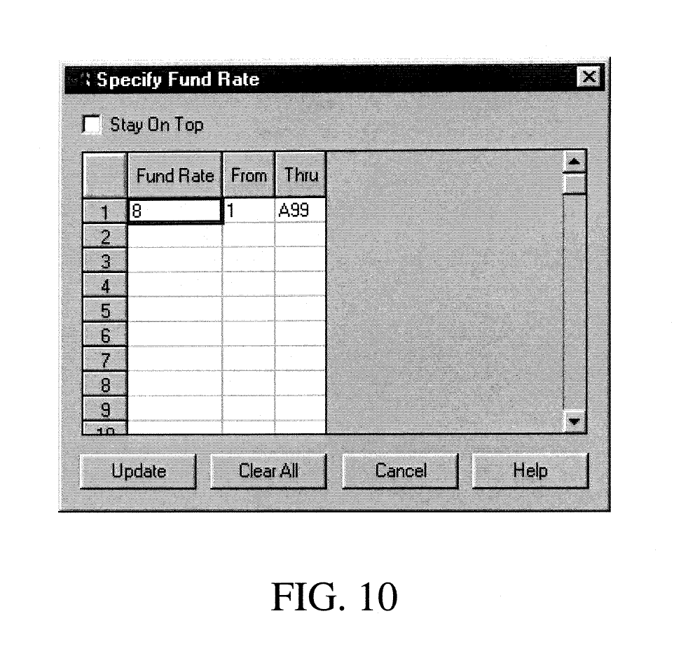

FIG. 9 illustrates another computer application screen of an embodiment which may be viewed by selecting tab 910, labeled “Funds.” This application screen contains entries for inputting an estimated rate of return for the invested assets of an illustrated proposed life insurance product. The invention uses the estimated rate of return to project the future balances of an insurance product's assets in order to determine if the assets are sufficient to pay projected product loads while maintaining the customer's desired benefits coverage. In embodiments, choosing button 920 will take the user to the application screen depicted in FIG. 10, where the user may enter the selected earnings rate, which may be fixed for the duration of the policy or may vary over time.

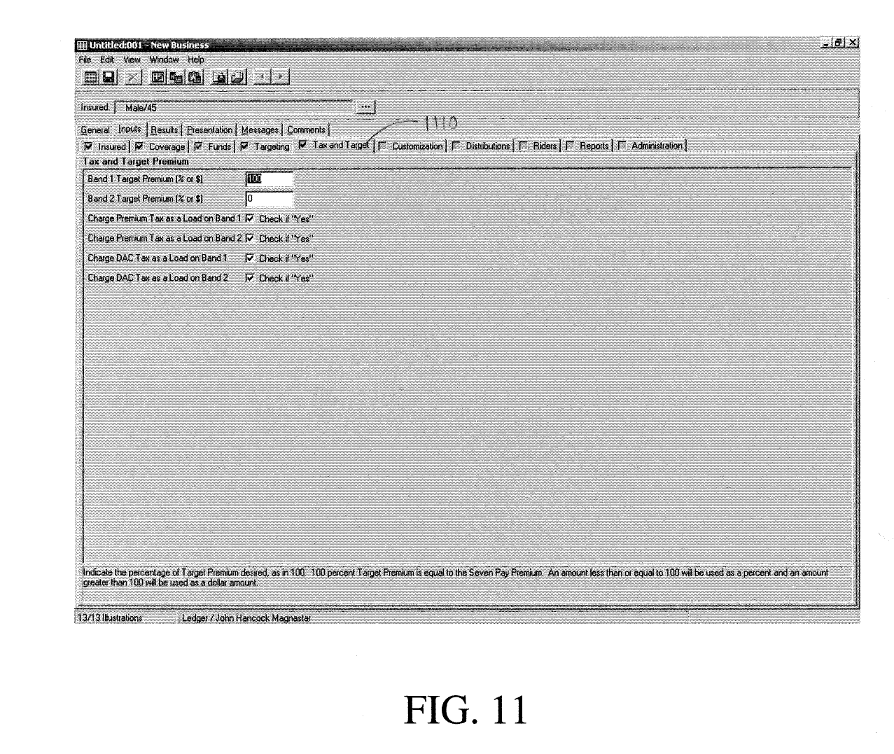

FIG. 11 illustrates another computer application screen of an embodiment which may be viewed by selecting tab 1110, labeled “Tax and Target.” The application screen contains entries for allocating premiums and amortizing government taxes associated with the life insurance product to a plurality of premium bands associated with the product. In this embodiment, the premium bands divide premium payments into different categories or bands based on dollar amounts. For example, the first premium band may be associated with the first amount of a premium payment, and a second premium band is associated with a next amount of the premium payment, and so on. The application screen illustrated in FIG. 11 allows a customer to define the premium bands and assign government taxes to be paid from a specific premium band.

In embodiments of the invention, Deferred Acquisition Cost (DAC) taxes that are deducted from the premium can also be deferred and amortized. Taxes can also be deferred on each, all, or any combination of premium bands for the same or different periods of time. For example, the period of deferral of taxes on premiums in a first band can be selected between, for example, one and ten years. In embodiments, deferral of taxes on premiums in a second band is available only for premiums applied in the first policy year. In embodiments, taxes on premiums in a third band may not be deferred at all.

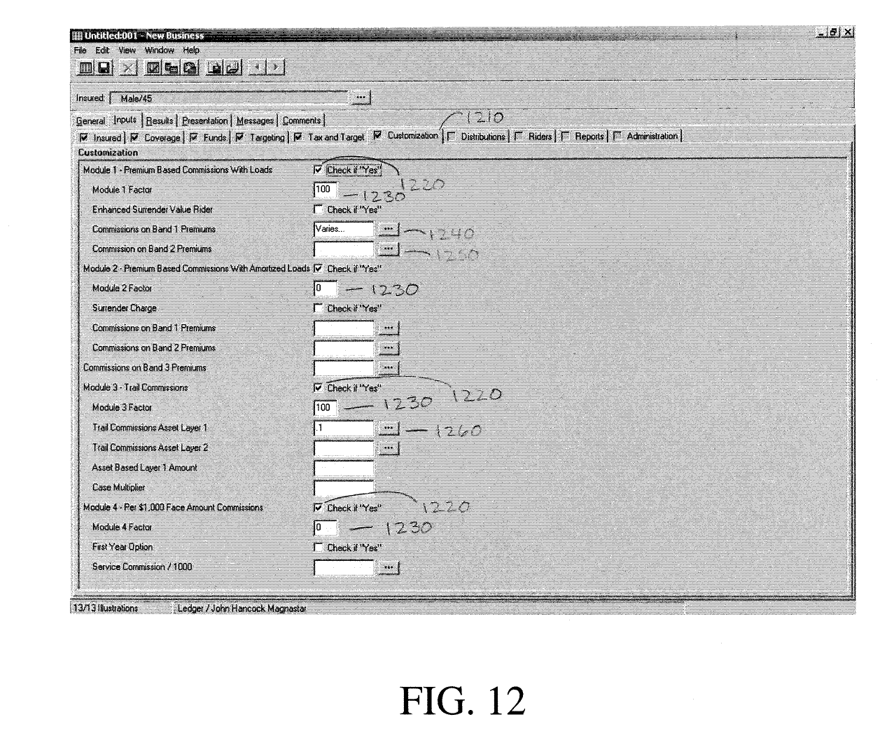

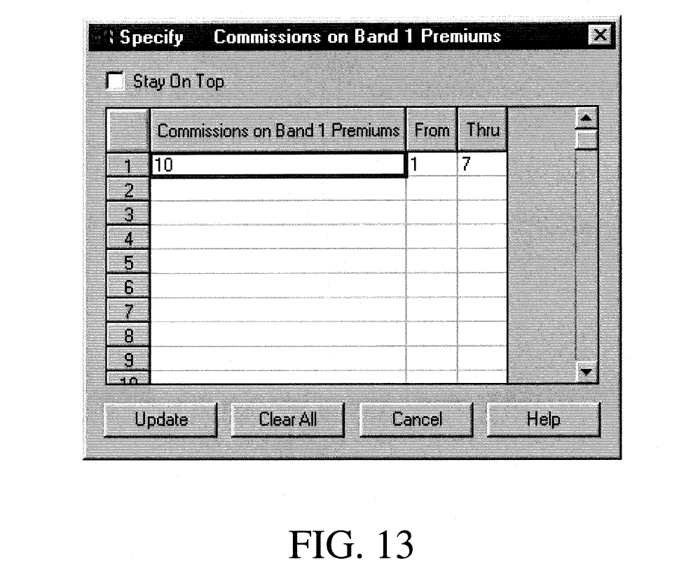

FIG. 12 illustrates another computer application screen of an embodiment which may be viewed by selecting tab 1210, labeled “Customization.” Using this application screen, an insurance representative can choose how sales commissions are charged to the policy. For example, if Module 1, entitled “Premium Commissions With Loads,” is selected, commission rates are specified and matched to the corresponding annual premium loads. In embodiments, choosing button 1240 will take the user to the application screen depicted in FIG. 13, where the user may enter the desired percentage of Band 1 premiums attributable to commissions for the various time periods of the policy. The percentage may be for the duration of the policy or may vary over time. For example, five percent of Band 1 premiums may be set aside for commission in the first five years of the policy, and in subsequent years, only three percent of Band 1 premiums will be set aside for commissions. Determining commission levels for Band 2 premiums may be accomplished by selecting button 1250, depicted in FIG. 12, and performing the same process.

Module 1 gives a representative or customer the ability to select a specific commission rate for each target premium band for each time period. In embodiments of the invention, early surrender values can be enhanced through use of an enhanced surrender value option. In embodiments, this option is available only in conjunction with Module 1, as depicted in FIG. 12. If the policy is surrendered during the first nine policy years, for example, a portion of the sales load will be added to the cash value upon surrender. In embodiments, a maximum commission rate may be fixed according to statutory requirements.

In Module 2 as depicted in FIG. 12, entitled “Premium Based Commissions With Amortized Loads,” commission rates are specified by the customer or representative but not matched by the corresponding commission sales loads. In embodiments, recovery of commission expenses occurs through amortization of other policy load elements. This module gives the ability to select a specific commission rate for each target premium band during the early policy time periods.

In addition, if the customer is not concerned with surrender values during the early years of the policy and is more interested in long-term performance, embodiments of the invention provide a surrender charge option. For example, surrender charges may apply only during the first nine years of the policy thus encouraging a customer to maintain the policy for at least that period of time. In embodiments, the level of surrender charges is responsive to the level of the target premium for the first premium band and to overall commission levels.

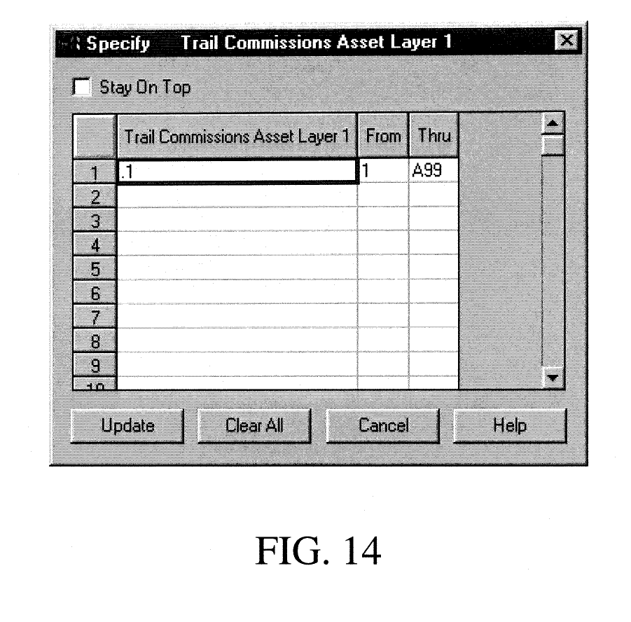

Module 3, as depicted in FIG. 12, is entitled “Trail Commissions” and provides a representative or a customer with the ability to specify asset-based trail-commissions. In life insurance products, the mortality and expense risk charge will generally vary in relation to the commission rate selected. Embodiments of the invention provide an option to set an asset band level above which a different trail commission will apply. This asset band can be based on the combined assets of multiple policies. In embodiments, choosing button 1260, will take the user to the application screen depicted in FIG. 14, where the user may enter the desired commission amounts. The commission may be fixed for the duration of the policy or may vary over time.

In Module 4 as depicted in FIG. 12, entitled “Per 51,000 Face Amount Commissions,” commissions can be payable as a flat fee per 51,000 of the face amount. In an embodiment, the commission can be specified annually and results in a charge to the policy taken over the duration of the policy. In embodiments of the invention, an option is provided for having the commission charged, for example, over the first ten policy years.

In embodiments, each of the four modules depicted in FIG. 12 can be used in various combinations by checking boxes 1220 and inputting module factors 1230. Module factors 1230 act as multipliers. For example, if the Module 1 factor is 200, the percent of Band 1 and Band 2 premiums previous chosen to be attributable to commissions would be doubled. Appendix D, Product Design and Flexibility, which is part of this specification, provides additional explanation of the interaction of the four modules.

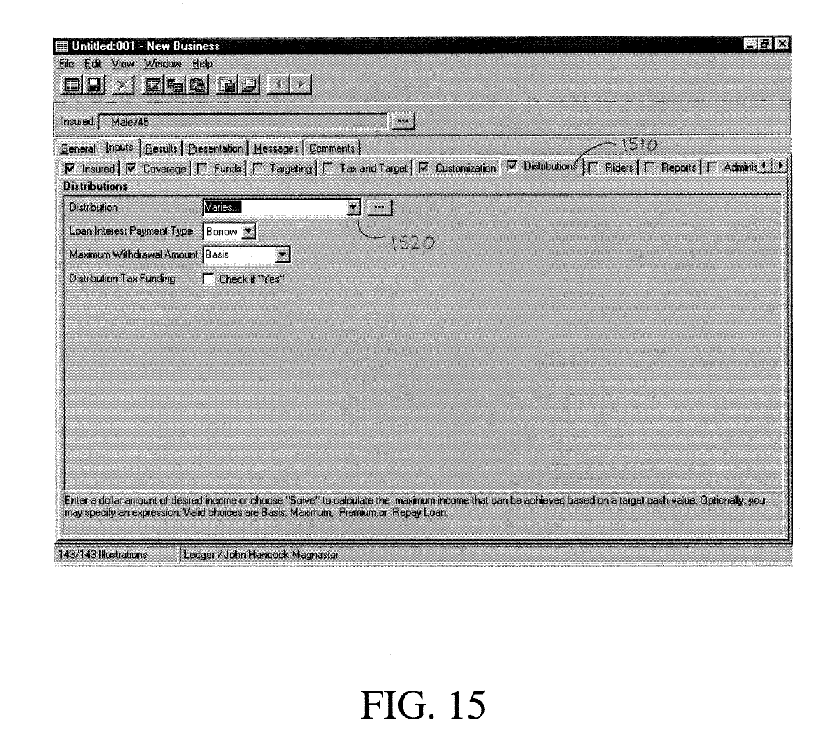

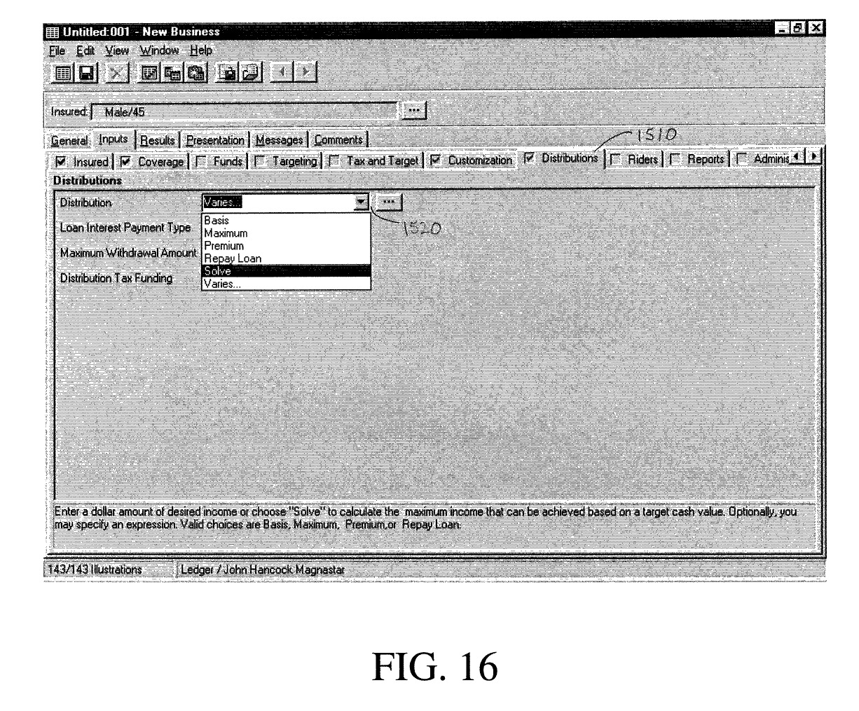

FIG. 15 illustrates another computer application screen of an embodiment which may be viewed by selecting tab 1510, labeled “Distributions.” Using this application screen, the user may select a desired income stream to be paid from the policy over time. In embodiments, choosing button 1520 will reveal the pull-down menu depicted in FIG. 16. From the pull-down menu, the user can select the type of distribution desired.

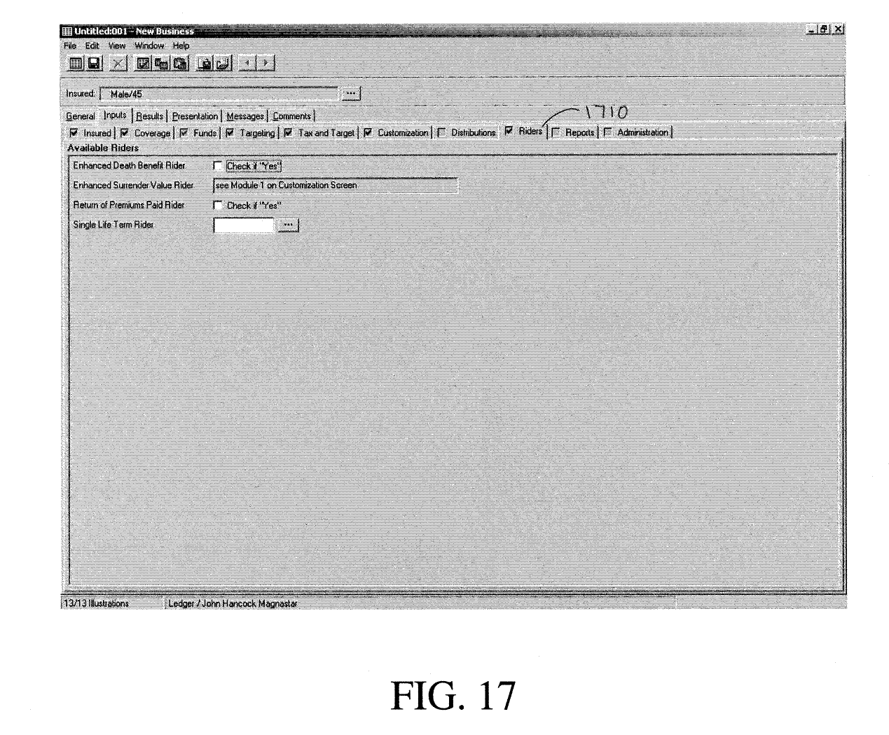

FIG. 17 illustrates another computer application screen of an embodiment which may be viewed by selecting tab 1710, labeled “Riders.” Using this application screen, the user may, for example, add an enhanced death benefit rider to the life insurance product. By choosing this option, excess cash value accumulated in the policy account will be used as an additional death benefit. The user may also select a rider that increases the death benefit by the amount of premiums paid, i.e., a return of premium rider.

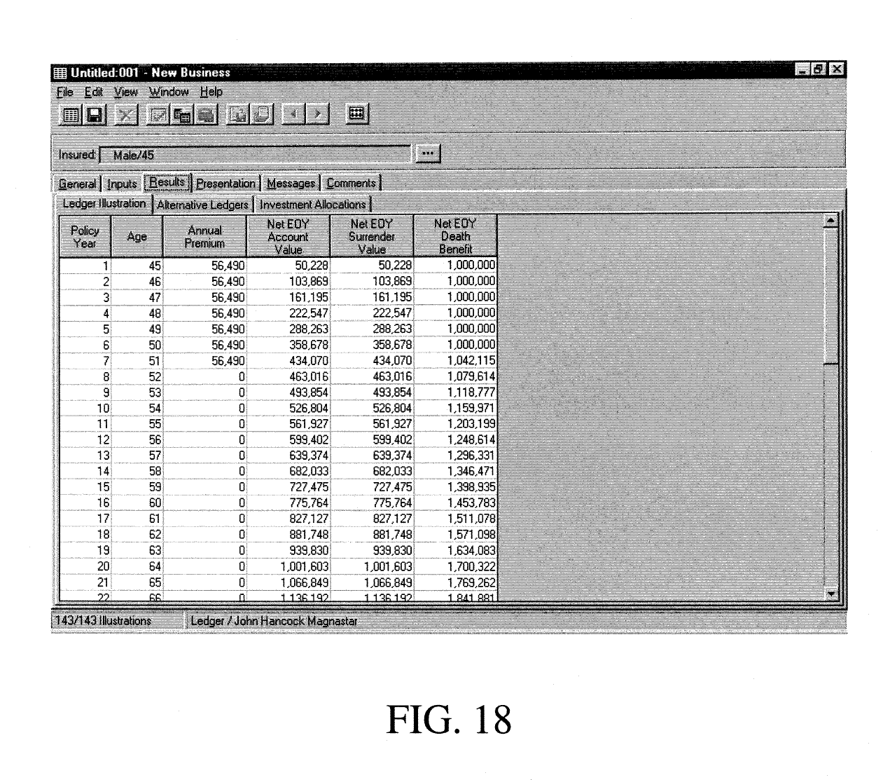

Once suitable selections have been made, as described above, embodiments of the invention then illustrate and/or generate schedules of premiums and account values associated with the policy for the user. The process of illustrating and/or generating policy schedules may involve processing the inputted values and selections according to the Product Definition in Appendix B and calculating factors for allocating policy charges to projected premiums and policy asset values. FIG. 18 illustrates an embodiment of another computer application screen which depicts an example of the data for an illustration of a life insurance product generated by inputs selected by a user. The screen shows the premium payment schedule as well as the projected account values of the policy and the projected death benefits of the policy. An example of a life insurance product illustration is shown in Appendix E, Product Illustration, for illustrative purposes and is part of this specification. Along with an Offering Memorandum, an example of which is illustrated in Appendix F, Illustrative Private Offering Memorandum, which is part of this specification, the life insurance product illustration defines the life insurance product offered to the customer.

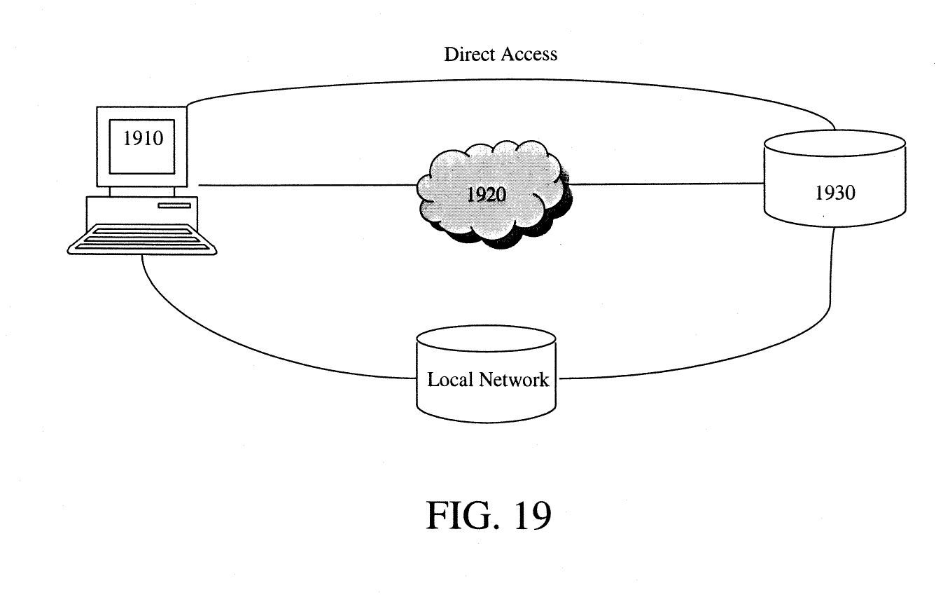

In an embodiment of the invention, the process of illustrating or generating life insurance products for a specific customer may be conducted using a laptop, a desktop, or other self-contained computer system that includes all of the data, tables, and programs for generating or illustrating a life insurance product according to the present invention. In other embodiments, the process of illustrating or generating life insurance products for a specific customer may be conducted using the Internet or other computer networking system. For example, as illustrated in FIG. 19, the system or program for illustrating or generating life insurance products that resides on computer system 1910 may require access to data and tables stored in computer system 1930. Access to computer system may 1930 be through the Internet 1920, a local area network, a direct access dial-up, or other computer or communications network.

In another embodiment of the invention, the system or programs for illustrating or generating life insurance products as well as the necessary data and tables may be accessed remotely using the Internet or a computer or communications network. In embodiments, the system or programs for illustrating or generating life insurance products and the necessary data and tables may be stored in separate remote computer systems.

More generally, as is apparent in view of this specification, including Appendices A-F, the present invention may be implemented using suitable computer and communications hardware or software or combinations thereof.

While there have been shown and described specific embodiments of the present invention, it should be apparent to those skilled in the art that various changes and modifications may be made without departing from the scope of the invention or its equivalents. The invention is intended to be broadly protected consistent with the spirit and scope of this specification and the appended documents.

What is claimed is:

1. A method for determining a premium schedule for a life insurance product under a single regulatory-approved form comprising:
(a) selecting a death benefit;
(b) targeting a projected balance of an account associated with the product;
(c) designating at least one premium band;
(d) generating, in response to a deferral determination for at least one premium-based charge for at least one premium band, factors for allocating charges associated with the product; and
(e) calculating, responsive to steps (a) through (d), the premium schedule.
